(19) United States
(12) Patent Application Publication
(10) Pub. No.: US 2021/0109713 A1
(43) Pub. Date: Apr. 15, 2021

(54) DEVICE AND METHOD FOR EXTRACTION AND INSERTION OF BINARY WORDS

(71) Applicants: STMicroelectronics (Grenoble 2) SAS, Grenoble (FR); STMicroelectronics (Rousset) SAS, Rousset Cedex (FR)

(72) Inventors: Rene Peyrard, Voiron (FR); Fabrice Romain, Rians (FR)

(21) Appl. No.: 17/038,584

(22) Filed: Sep. 30, 2020

(30) Foreign Application Priority Data
Oct. 11, 2019 (FR) 1911349

(51) Int. Cl. G06F 7/76; G06F 7/494; G06F 7/496; G06F 7/72

(52) U.S. Cl. CPC G06F 7/764; G06F 7/727; G06F 7/496; G06F 7/494

(57) ABSTRACT

The present disclosure relates to a device and method for processing masked binary data values, comprising extracting and inserting a first part of a first masked binary data value in a second masked binary data value, in which the first and second masked binary data values stay masked throughout all of the processing.

### CROSS-REFERENCE TO RELATED APPLICATIONS

This application claims the benefit of French Application No. 1911349, filed on Oct. 11 2019, which application is hereby incorporated herein by reference.

### TECHNICAL FIELD

The present disclosure relates generally to electronic systems, circuits and methods, and more specifically to methods and electronic devices configured to perform calculations on binary words, such as processors, for example. The present disclosure more specifically relates to methods and devices configured to process masked data values.

### BACKGROUND

Among the various devices that are configured to perform calculations on binary words, processors are electronic components, present in many electronic systems and circuits, that are configured to process data values by executing commands and instructions from computer programs.

In some cases, a processor may have to process secret data values. These secret data values are generally encrypted, for example by masking.

It would be desirable to be able to improve, at least partially, certain aspects of known devices configured to perform calculations on binary words.

### SUMMARY

There is a need for more reliable devices configured to perform calculations on binary words.

There is a need for devices configured to perform calculations on binary words configured to process masked data values.

There is a need for devices configured to perform calculations on binary words configured to process masked data values without implementing an operation to unmask these data values.

One embodiment addresses all or some of the drawbacks of the known devices configured to perform calculations on binary words.

One embodiment addresses all or some of the drawbacks of known processors configured to process masked data values.

One embodiment provides a method for processing masked binary data values, implemented by a device configured to perform calculations on binary data values, comprising an operation for the extraction and insertion of a first part of a first masked binary data value in a second masked binary data value, in which the first and second masked binary data values stay masked throughout all of the processing.

According to one embodiment, the method does not comprise any unmasking operation of the first and second masked binary data values.

According to one embodiment, the first and second masked binary data values are masked by a masking operation only comprising arithmetic operations.

According to one embodiment, the masking operation is an operation in which the data value to be masked is added to a mask in order to obtain the masked data value.

According to one embodiment, a third binary data value is the result of the extraction and insertion operation, the third binary data value is a data value masked by a third mask.

According to one embodiment, the second masked binary data value is obtained by performing a masking operation of a binary data value for which all of the bits are equal to “o”.

According to one embodiment, the second masked binary data value is equal to a second mask used during the masking operation.

According to one embodiment, the third masked binary data value Z_M is given by the following formula:

Z_M[n−1;0]=(Z_M[n−1;p+1]*2^{p+1}+CB(p+m)*2^{p}+B_M[p+m−1;m])mod2ⁿ

wherein:

“+” represents the addition operation;

“mod” represents the modulo operation;

n represents the number of bits of the third masked binary data value Z_M, n being a natural integer;

p is a natural integer of between o and n−1;

m is a natural integer of between o and n−p;

P[i;j] represents all of the bits of a binary data value P ranging from a rank i to a rank j; i and j being natural integers;

CB(i) represents the carry digit of rank i that may appear during the masking operation leading to a first masked data value;

B_M represents the first masked data value,

the carry digit CB(i+1), i being a natural integer less than or equal to n, is given by the following formulas:

$$\{ \begin{matrix}if B\_M [ i ; 0 ] < M B [ i ; 0 ] then CB ( i + 1 ) = 1 \\ if B\_M [ i ; 0 ] \geq M B [ i ; 0 ] then CB ( i + 1 ) = 0\end{matrix}$$

wherein MB represents a first mask associated with the first masked binary data value, and the third mask MZ associated with the third masked binary data value is given by the following formula:

MZ[n−1;0]=(MZ[n−1;p+1]*2^{(p+1)}+CB(m)+(m)+MB[p+m−1;m])mod2ⁿ

According to one embodiment, the third masked binary data value X_M is given by the following formula:

X_M[n−1;0]=(Z_M[n−1;p+1]*2^{p+1}+CB(p+m)*2^{P}+B_M[p+m−1;m]−CB(m))mod2ⁿ

wherein:

“+” represents the addition operation;

“mod” represents the modulo operation;

n represents the number of bits of the third masked binary data value X_M, n being a natural integer;

p is a natural integer of between o and n−1;

m is a natural integer of between o and n−p;

P[i;j] represents all of the bits of a binary data value P ranging from a rank i to a rank j; i and j being natural integers;

CB(i) represents the carry digit of rank i that may appear during the masking operation leading to the first masked data value;

B_M represents the first masked data value,

the carry digit CB(i+1), i being a natural integer less than or equal to n, is given by the following formulas:

$$\{ \begin{matrix}if B\_M [ i ; 0 ] < M B [ i ; 0 ] then CB ( i + 1 ) = 1 \\ if B\_M [ i ; 0 ] \geq M B [ i ; 0 ] then CB ( i + 1 ) = 0\end{matrix}$$

wherein MB represents the first mask associated with the first masked binary data value, and the third mask NIX associated with the third masked binary data value is given by the following formula:

MX[n−1;0]=(MX[n−1;p+1]*2^{(p+1)}+MB[p+m−1;m])mod2ⁿ

According to one embodiment, the third masked binary data value F_M is given by the following formula:

F_M[n−1;0]={(E_M[n−1;k+p]+CEF(k+p))*2\hat{ }((k+p))+(D_M[m+p−1;m]+ME[k+p−−1;k]−MD[m+p−1;m]+CE(k)−CD(k))*2\hat{ }k+E_M[k−1;0]}mod2\hat{ }n

wherein:

“+” represents the addition operation;

“mod” represents the modulo operation;

n represents the number of bits of the third masked binary data value X_M, n being a natural integer;

p is a natural integer of between o and n−1;

m is a natural integer of between o and n−p;

k is a natural integer of between o and n−p;

P[i;j] represents all of the bits of a binary data value P ranging from a rank i to a rank j; i and j being natural integers;

CEF(i) represents a carry digit correction with rank i;

CD(i) represents the carry digit of rank i that may appear during the masking operation leading to the first masked data value;

CD(i) represents the carry digit of rank i that may appear during the masking operation leading to the second masked data value;

D_M represents the first masked data value;

MD represents a mask associated with the first masked data value;

E_M represents the second masked data value; and

ME represents a mask associated with the second masked data value, the carry digit CD(i+1) is given by the following formulas:

$$\{ \begin{matrix}if D\_M [ i ; 0 ] < MD [ i ; 0 ] then CD ( i + 1 ) = 1 \\ if D\_M [ i ; 0 ] \geq MD [ i ; 0 ] then CD ( i + 1 ) = 0\end{matrix}$$

the carry digit CE(i+1) is given by the following formulas:

$$\{ \begin{matrix}if E\_M [ i ; 0 ] < ME [ i ; 0 ] then CE ( i + 1 ) = 1 \\ if E\_M [ i ; 0 ] < ME [ i ; 0 ] then CE ( i + 1 ) = 0\end{matrix}$$

the carry digit correction CEF(i) is given by the following formula:

$$\{ \begin{matrix}if CE ( i ) = C F ( i ) then CEF ( i ) = 0 \\ if CE ( i ) = 0 and CF ( i ) = 1 then CEF ( i ) = 1 \\ if CE ( i ) = 1 and CF ( i ) = 0 then CEF ( i ) = - 1\end{matrix}$$

the third mask associated with the third binary data value is equal to the mask associated with the second masked data value.

The method according to claim 5, wherein the third masked binary data value F_M is given by the following formula:

F_M[n−1;0]={E_M[n−1;k+p]*2^{(k+p)}+(D_M[m+p−1;m]+ME[k+p−1;k]−MD[m+p−1;m]+CE(k)−CD(k))*2^{k}+E_M[k−1;0]}mod2ⁿ

wherein:

“+” represents the addition operation;

“mod” represents the modulo operation;

n represents the number of bits of the third masked binary data value X_M, n being a natural integer;

p is a natural integer of between o and n−1;

m is a natural integer of between o and n−p;

k is a natural integer of between o and n−p;

P[i;j] represents all of the bits of a binary data value P ranging from a rank i to a rank j; i and j being natural integers;

CD(i) represents the carry digit of rank i that may appear during the masking operation leading to the first masked data value;

CD(i) represents the carry digit of rank i that may appear during the masking operation leading to the second masked data value;

D_M represents the first masked data value;

MD represents a mask associated with the first masked data value;

E_M represents the second masked data value; and

ME represents a mask associated with the second masked data value, the carry digit CD(i+1) is given by the following formulas:

$$\{ \begin{matrix}if D\_M [ i ; 0 ] < MD [ i ; 0 ] then CD ( i + 1 ) = 1 \\ if D\_M [ i ; 0 ] \geq MD [ i ; 0 ] then CD ( i + 1 ) = 0\end{matrix}$$

the carry digit CE(i+1) is given by the following formulas:

$$\{ \begin{matrix}if E\_M [ i ; 0 ] < ME [ i ; 0 ] then CE ( i + 1 ) = 1 \\ if E\_M [ i ; 0 ] < ME [ i ; 0 ] then CE ( i + 1 ) = 0\end{matrix}$$

the third mask MF associated with the third binary data value is given by the following formula:

MF[n−1;0]=ME[n−1;0]−CEF(k+p)*2^{k+p}

wherein CEF(i) represents a carry digit correction with rank i given by the following formula:

$$\{ \begin{matrix}if CE ( i ) = C F ( i ) then CEF ( i ) = 0 \\ if CE ( i ) = 0 and CF ( i ) = 1 then CEF ( i ) = 1 \\ if CE ( i ) = 1 and CF ( i ) = 0 then CEF ( i ) = - 1\end{matrix}$$

According to one embodiment, the third masked binary data value I_M is given by the following formula:

I_M[n−1;0]={(H_M[n−1;k+p]−CH(k+p))*2^{(k+p)}+(G_M[m+p−1;m]−CG(m) +CG(m+p)*2^{p})*2^{k}+(H_M[k−1;0]+CH(k)*2^{k})}mod2ⁿ

wherein:

“+” represents the addition operation;

“mod” represents the modulo operation;

n represents the number of bits of the third masked binary data value X_M, n being a natural integer;

p is a natural integer of between o and n−1;

m is a natural integer of between o and n−p;

k is a natural integer of between o and n−p;

P[i;j] represents all of the bits of a binary data value P ranging from a rank i to a rank j; i and j being natural integers;

CG(i) represents the carry digit of rank i that may appear during the masking operation leading to the first masked data value;

CH(i) represents the carry digit of rank i that may appear during the masking operation leading to the second masked data value;

G_M represents the first masked data value;

G_M represents the second masked data value; and the carry digit CG(i+1) is given by the following formulas:

$$\{ \begin{matrix}if G\_M [ i ; 0 ] < MG [ i ; 0 ] then CG ( i + 1 ) = 1 \\ if G\_M [ i ; 0 ] \geq MG [ i ; 0 ] then CG ( i + 1 ) = 0\end{matrix}$$

the carry digit CH(i+1) is given by the following formulas:

$$\{ \begin{matrix}if H\_M [ i ; 0 ] < MH [ i ; 0 ] then CH ( i + 1 ) = 1 \\ if H\_M [ i ; 0 ] \geq NH [ i ; 0 ] then CH ( i + 1 ) = 0\end{matrix}$$

the third mask MI associated with the third masked binary data value is given by the following formula:

MI[n−1;0]=MH[n−1;k+p]*2^{p+k}+MG[m+p−1;m]*2^{k}+MH[k−1;0]

wherein:

wherein MG represents the mask associated with the first masked binary data value; and

wherein MH represents the mask associated with the second masked binary data value.

According to one embodiment, the third masked binary data value I_M is given by the following formula:

I_M[n−1;0]={H_M[n−1;k+p]*2^{(k+p)}+(G_M[m+p−1;m]+CG(m+p)*2^{p})*2^{k}+(H_M[k−1;0]+CH(k)*2^{k})}mod2ⁿ

wherein:

“+” represents the addition operation;

“mod” represents the modulo operation;

n represents the number of bits of the third masked binary data value X_M, n being a natural integer;

p is a natural integer of between o and n−1;

m is a natural integer of between o and n−p;

k is a natural integer of between o and n−p;

P[i;j] represents all of the bits of a binary data value P ranging from a rank i to a rank j; i and j being natural integers;

CG(i) represents the carry digit of rank i that may appear during the masking operation leading to the first masked data value;

CH(i) represents the carry digit of rank i that may appear during the masking operation leading to the second masked data value;

G_M represents the first masked data value;

G_M represents the second masked data value; and the carry digit CG(i+1) is given by the following formulas:

$$\{ \begin{matrix}if G\_M [ i ; 0 ] < MG [ i ; 0 ] then CG ( i + 1 ) = 1 \\ if G\_M [ i ; 0 ] \geq MG [ i ; 0 ] then CG ( i + 1 ) = 0\end{matrix}$$

the carry digit CH(i+1) is given by the following formulas:

$$\{ \begin{matrix}if H\_M [ i ; 0 ] < MH [ i ; 0 ] then CH ( i + 1 ) = 1 \\ if H\_M [ i ; 0 ] \geq NH [ i ; 0 ] then CH ( i + 1 ) = 0\end{matrix}$$

the third mask MI associated with the third masked binary data value is given by the following formula:

MI[n−1;0]=(MH[n−1;k+p]+CH(k+p))*2^{p+k}+(MG[m+p−1;m]+CG(m))*2^{k}+)MH[k−1;0]

wherein:

wherein MG represents the mask associated with the first masked binary data value; and

wherein MH represents the mask associated with the second masked binary data value.

Another embodiment provides a device configured to perform calculations on binary data values masked by a masking operation previously disclosed, the device being configured to carry out the method previously disclosed.

Electronic device comprising a device as previously disclosed.

### BRIEF DESCRIPTION OF THE DRAWINGS

The foregoing features and advantages, as well as others, will be described in detail in the following description of specific embodiments given by way of illustration and not limitation with reference to the accompanying drawings, in which:

FIG. 1 shows, schematically and in block diagram form, an embodiment of a processor;

FIG. 2 schematically shows an embodiment of a method for processing masked binary data values;

FIG. 3 schematically shows another embodiment of a method for processing masked binary data values;

FIG. 4 schematically shows another embodiment of a method for processing masked binary data values;

FIG. 5 schematically shows another embodiment of a method for processing masked binary data values.

### DETAILED DESCRIPTION OF ILLUSTRATIVE EMBODIMENTS

Like features have been designated by like references in the various figures. In particular, the structural and/or functional features that are common among the various embodiments may have the same references and may dispose identical structural, dimensional and material properties.

For the sake of clarity, only the operations and elements that are useful for an understanding of the embodiments described herein have been illustrated and described in detail.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following disclosure, unless indicated otherwise, when reference is made to absolute positional qualifiers, such as the terms “front”, “back”, “top”, “bottom”, “left”, “right”, etc., or to relative positional qualifiers, such as the terms “above”, “below”, “higher”, “lower”, etc., or to qualifiers of orientation, such as “horizontal”, “vertical”, etc., reference is made to the orientation shown in the figures.

Unless specified otherwise, the expressions “around”, “approximately”, “substantially” and “in the order of” signify within 10%, and preferably within 5%.

In the remainder of the disclosure, consideration is given to the data values, masked data values and masks, which are all binary words, for example with n bits, n being a natural integer. The following notation will be used:

P[m;k] designates the set of bits going from rank k to rank m of a binary word P, m and k being natural integers less than or equal to n, m being strictly greater than k; and

P[m] designates the bit with rank m of the binary word P.

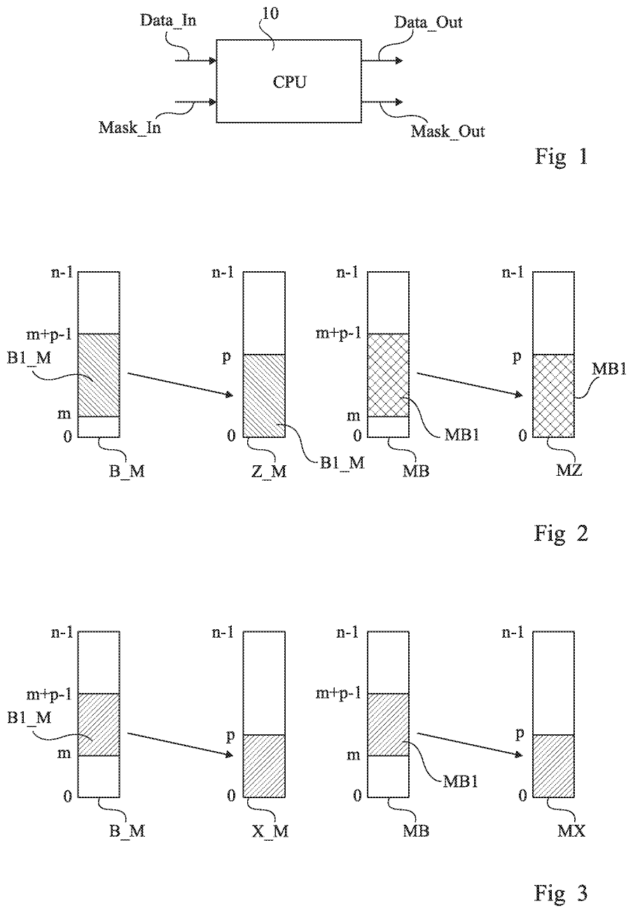

FIG. 1 illustrates, very schematically and in block diagram form, an embodiment of a processor 10 (CPU). The processor can, inter alia, receive and supply data values to electronic components, for example memories, of an electronic device to which it belongs. As a variant, the processor 10 could be any entity configured to perform calculations on binary words, for example an electronic device configured to perform cryptography calculations.

The processor 10 is configured, inter alia, to process data values, and particularly masked data values. The processor receives masked data values Data_In, and their masks Mask_In, as input, and supplies masked data values Data_Out, and their masks Mask_Out, as output.

The input data values Data_In, respectively the output data values Data_Out, are masked with the masks Mask_In, respectively Mask_Out, by implementing masking of the arithmetic type. Masking of the arithmetic type is masking that only comprises arithmetic operations as opposed to logic operations. Arithmetic masking is, in the case described here, additive masking in which the mask is added to the data value to be masked. As an example, the mask and the data value to be masked are binary words of equal size. According to a variant, the mask and the data value to be masked are binary words of different sizes. More specifically, a masked data value A_M is given by the following formula:

A_M=(A+MA) mod2ⁿ

wherein:

A represents the data value to be masked;

MA represents the mask;

“+” represents the addition operation;

“mod” represents the modulo operation; and

n is the number of bits that make up the data value to be masked A, the mask MA and the masked data value A_M.

The processor 10 is configured to process the masked data values Data_In, and their masks Mask_In, by applying different operations to them, for example, addition, subtraction, complementary to 1 operations, or data values processing operations by extracting data values parts and inserting these parts into other data values. Embodiments of extraction and insertion operations carried out by the processor 10 are disclosed in relation with FIGS. 2 to 5.

FIG. 2 illustrates, schematically, an embodiment of a method for processing masked data values comprising an operation to extract data values parts and insert these parts into other data values, carried out by the processor 10 disclosed in relation with FIG. 1. The extraction and insertion operation disclosed in relation with FIG. 2 is an extraction and insertion operation the to be “with compensation by the mask”.

The embodiment disclosed in relation with FIG. 2 is a specific case of an extraction and insertion operation for part of a binary word in a nil data value, that is to say, a binary word for which all of its bits are equal to “o”. Applying a masking operation, of the type disclosed in relation with FIG. 1, to the nil data value provides a masked data value equal to the mask that is associated with it.

In order to illustrate the operation of this embodiment, two masked data values B_M and Z_M are considered, as well as their masks MB and MZ. The masked data value B_M is the result of an additive masking operation, disclosed in relation with FIG. 1, of the data value B by the mask MB. The masked data value Z_M is the result of an additive masking operation, disclosed in relation with FIG. 1, of the data value Z by the mask MZ, thus, initially the data value Z_M is equal to the mask MZ. The binary words that make up the data values B_M, B, Z_M and the masks MB and MZ are, in the case disclosed here, all binary words with n bits, n being a natural integer.

During an extraction and insertion operation, part of a data value, in the case illustrated here a part B1_M of the masked data value B_M, is extracted, then inserted into a second data value, in the case disclosed here the data value Z_M. Since the data value B_M is a masked data value with mask MB, a part MBi of the mask MB is further extracted, then inserted into the mask MZ. The part MB1 has the same place in the mask MB as the part B1_M in the masked data value B_M.

More specifically, the part B1_M extracted from the masked data value B_M is a binary word with p bits, p being a natural integer less than or equal to n, corresponding to the bits of the masked data value B_M going from a rank m to a rank m+p−1, m being a natural integer of between o and n−p. Likewise, the part MBi extracted from the mask MB is a binary word with p bits, corresponding to the bits of the mask MB going from rank m to rank m+p−1.

According to one embodiment, the part B1_M is inserted into the data value Z_M, and p+1 bits of the data value Z_M are modified. As an example, the p+1 bits of low weight of the data value Z_M are modified, but as a variant, the p+1 modified bits can be in any place in the data value Z_M. When the p+1 modified bits are bits of low weight, the data value Z_M is given by the following formula:

Z_M[n−1;0]=(Z_M[n−1;p+1]*2^{p+1}+CB(p+m)*2^{p}+B_M[p+m−1;m])mod2ⁿ

wherein CB(i) represents the carry digit with rank i, i being an integer of between 1 and n, which can appear during the additive masking operation of the data value B, disclosed in relation with FIG. 1, with the mask MB, leading to the data value B_M.

The carry digit CB(i+1) is given by the following formulas:

$$\{ \begin{matrix}if B\_M [ i ; 0 ] < MB [ i ; 0 ] then CB ( i + 1 ) = 1 \\ if B\_M [ i ; 0 ] \geq MB [ i ; 0 ] then CB ( i + 1 ) = 0\end{matrix}$$

The part MB1 is inserted into the mask MZ, and p+1 bits of the mask MZ are modified. As an example, the p+1 bits of low weight of the mask MZ are modified, but as a variant, the p+1 modified bits can be in any place in the mask MZ. The p+1 modified bits of the mask MZ are positioned in the same place as the p+1 modified bits of the data value Z_M. When the p+1 modified bits are bits of low weight, the mask MZ is given by the following formula:

MZ[n−1;0]=(MZ[n−1; p+1]*2^{(p+1)}CB(m)+MB[p+m−1;m])mod2ⁿ

The extraction and insertion operation the to be “with compensation by the mask”, since the carry digit CB(m) is added to the mask MZ, the carry digit is the to be compensated by the mask. A variant in which the carry digit is compensated differently is disclosed in relation with FIG. 3.

The masked data value Z_M and the mask MZ make it possible to find the nil data value again:

Z[n−1;0]=(Z_M[n−1;0]MZ[n−1;0])mod2ⁿ

The data value Z is then given by the following simplified formula:

Z[n−1;0]=B[m+p−1;m]

One advantage of this embodiment is that the extraction and insertion operation disclosed in relation with FIG. 2 does not comprise a step for unmasking the masked data value B_M. Thus, the data value B is not accessible during this operation.

Another advantage of this embodiment is that it makes it possible to add diversity among the masks used to mask data values.

FIG. 3 illustrates, schematically, another embodiment of a method for processing masked data values comprising an extraction and insertion operation carried out by the processor 10 disclosed in relation with FIG. 1. The extraction and insertion operation disclosed in relation with FIG. 3 is an extraction and insertion operation the to be “with compensation by the masked data value”.

The operation disclosed in relation with FIG. 3 is similar to the operation disclosed in relation with FIG. 2. The elements shared by the two operations will not be described again.

In order to illustrate the operation of this embodiment, the masked data value B_M and its mask MB are considered, as well as a masked data value X_M and its mask MX. The masked data value X_M is the result of an additive masking operation, disclosed in relation with FIG. 1, of a nil data value X by the mask MX, thus, initially the data value X_M is equal to the mask MX. The binary words that make up the masked data value X_M and the mask MX are binary words with n bits.

It is considered here that the part B1_M of the masked data value B_M is extracted, then inserted into the neutral data value X_M. The part MBi of the mask MB is further extracted, then inserted into the mask MX.

Like in FIG. 2, the part B1_M extracted from the masked data value B_M is a binary word with p bits corresponding to the bits of the masked data value B_M going from rank m to rank m+p−1. Likewise, the part MB1 extracted from the mask MB is a binary word with p bits, corresponding to the bits of the mask MB going from rank m to rank m+p−1.

The extraction and insertion operation disclosed here is the to be “with compensation on the masked data value”, thus the carry digit CB(m) with rank m that may appear during the additive masking operation with the mask MB leading to the data value B_M is compensated on the masked data value X_M, and not on the mask MX.

In this case, the masked data value X_M is given by the following formula:

X_M[n−1;0]=(X_M[n−1;p]*2^{p+1}+CB(p+m)*2^{p}+B_M[p+m−1;m]−CB(m))mod2ⁿ

The mask MX is given by the following formula:

MX[n−1;0]=(MX[n−1;p+1]*2^{(p+1)}+MB[p+m−1;m])mod2ⁿ

Like in FIG. 2, the masked data value X_M and its mask MX are equal before insertion of the masked data value B_M and its mask MB. After this operation, the binary words X_M[n−1;p−1] and MX[n−1;p−1] After the masked data value X_M and the mask MX defined by the formulas given above, that is to say, before the insertion operation, it is possible to find the data value X again by unmasking the data value X_M by applying the following formula:

X[n−1;0]=X_M[n−1;0]MX[n−1;0]

The data value X is then given by the following formula:

X[n−1;0]=B[m+p−1;m]

One advantage of this embodiment is that the extraction and insertion operation disclosed in relation with FIG. 2 does not comprise a step for unmasking the masked data value B_M. Thus, the data value B is not accessible during this operation.

Another advantage of this embodiment is that it can be used with masked data values whose masks are not modifiable data values.

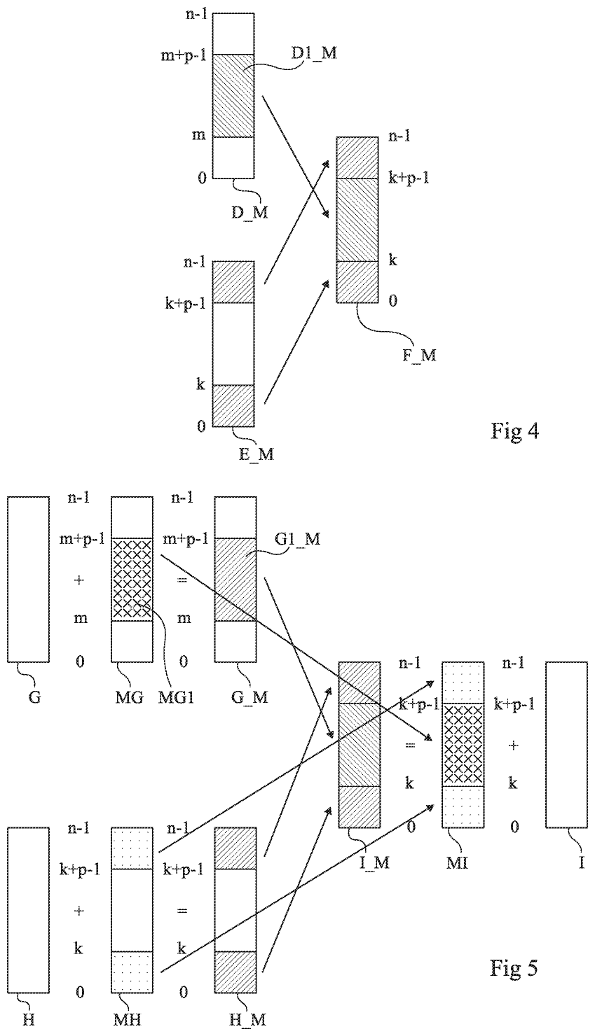

FIG. 4 illustrates, schematically, another embodiment of a method for processing masked data values comprising an extraction and insertion operation carried out by the processor 10 disclosed in relation with FIG. 1.

The embodiment disclosed in relation with FIG. 4 is a more general case than the cases disclosed in relation with FIGS. 2 and 3. Indeed, in the case disclosed in relation with FIG. 4, a part of a first masked data value is extracted, then inserted into another masked data value.

To illustrate the operation of this embodiment, three masked data values D_M, E_M and F_M are considered. The masked data value D_M, respectively E_M, F_M, is the result of an additive masking operation, disclosed in relation with FIG. 1, of the data value D, respectively E, F, by the mask MD, respectively ME, MF. The data values D_M, D, E_M, E, F_M, F and the masks MD, ME and MF are all binary words with n bits.

In the extraction and insertion operation disclosed in relation with FIG. 4, a part D1_M of the masked data value D_M is extracted, then inserted into the masked data value E_M in order to form the final masked data value F_M. According to one embodiment, the mask MF associated with the masked data value F_M is equal to the mask ME associated with the data value E_M. A variant in which the mask MF is different is disclosed in relation with FIG. 5.

More specifically, the part D1_M extracted from the masked data value D_M is a binary word with p bits, p being a natural integer less than or equal to n, corresponding to the bits of the masked data value D_M going from a rank m to a rank m+p−1, m being a natural integer of between o and n-p.

According to one embodiment, the part D1_M is inserted into the masked data value E_M, in order to form the masked data value F_M, and more specifically, p bits of the masked data value E_M going from rank k to rank k+p−1 are modified in order to form the masked data value F_M, k being a natural integer from o to n-p. As disclosed in relation with FIGS. 2 and 3, the extraction and insertion operation can be with “compensation on the mask” or “compensation on the masked data value”.

The extraction and insertion operation disclosed here is intended to generate the masked data value F_M such that the data value F, obtained by unmasking the masked data value F_M with the mask MF, is equal to the data value E in which one has inserted, between ranks k and k+p−1, p bits of the data value D going from a rank m to a rank m+p−1.

In the case where the extraction and insertion operation is with “compensation on the masked data value”, the masked data value F_M is then given by the following formula:

F_M[n−1;0]={(E_M[n−1;k+p]+CEF(k+p))*2^{(k+p)}+(D_M[m+p−1;m]+ME[k+p−1;k]−MD[m+p−1;m]+CE(k)−CD(k))*2^{k}+E_M[k−1;0]}mod2ⁿ

wherein:

CEF(i) represents a carry digit correction with rank i, i being an integer between 1 and n, defined hereinafter;

CD(i) represents a carry digit of rank i that may appear during the additive masking operation, with the mask ME, leading to the masked data value E_M; and

CD(i) represents a carry digit of rank i that may appear during the additive masking operation, with the mask MD, leading to the masked data value D_M.

The carry digit CE(i+1) is given by the following formulas:

$$\{ \begin{matrix}if {E}_{M [ i ; 0 ]} < ME [ i ; 0 ] then CE ( i + 1 ) = 1 \\ if E\_M [ i ; 0 ] \geq ME [ i ; 0 ] then CE ( i + 1 ) = 0\end{matrix}$$

The carry digit CD(i+1) is given by the following formulas:

$$\{ \begin{matrix}if D\_M [ i ; 0 ] < MD [ i ; 0 ] then CD ( i + 1 ) = 1 \\ if D\_M [ i ; 0 ] \geq MD [ i ; 0 ] then CD ( i + 1 ) = 0\end{matrix}$$

The carry digit correction CEF(i+1) depends on the carry digit CE(i+1) and a carry digit CF(i+1), and is given by the following formulas:

$$\{ \begin{matrix}if CE ( i ) = CF ( i ) then CEF ( i ) = 0 \\ if CE ( i ) = 0 and CF ( i ) = 1 then CEF ( i ) = 1 \\ if CE ( i ) = 1 and CF ( i ) = 0 then CEF ( i ) = - 1\end{matrix}$$

The mask MF associated with the masked data value F_M is, in the case of an operation with “compensation on the masked data value”, strictly equal to the mask ME associated with the data value E_M.

In the case where the extraction and insertion operation is with “compensation on the mask”, the masked data value F_M is then given by the following formula:

F_M[n−1;0]={E_M[n−1;k+p]*2^{(k+p)}+(D_M[m+p−1;m]+ME[k+p−1;k]−MD[m+p−1;m]+CE(k)−CD(k))*2^{k}+E_M[k−1;0]}mod2ⁿ

The mask MF is given by the following formula:

MF[n−1;0]=ME[n−1;0]−CEF(k+p)*2^{k+p}

Whether in the case of an extraction and insertion operation with “compensation by the mask” or “with compensation by the masked data value”, the formulas defined above make it possible to find the data value F again from the masked data value F_M and the mask MF by applying an unmasking operation defined by the following formula:

F[n−1;0]=(F_M[n−1;0]MF[n−1;0])mod2ⁿ

One advantage of these embodiments is that the extraction and insertion operation does not require an unmasking operation for the masked data values D_M, E_M and F_M. Thus the data values D, E and F are not accessible during this operation.

FIG. 5 illustrates, schematically, another embodiment of a method for processing masked data values comprising an extraction and insertion operation carried out by the processor 10 disclosed in relation with FIG. 1.

The operation disclosed in relation with FIG. 5 is similar to the operation disclosed in relation with FIG. 4. The elements shared by the two operations will not be described again.

To illustrate the operation of this embodiment, data values G_M, H_M and I_M are considered, as well as their masks MG, MH and MI. The masked data value G_M, respectively H_M, I_M, is the result of an arithmetic masking operation, disclosed in relation with FIG. 1, of a data value G, respectively H, I, with the mask MG, respectively MH, MI. The binary words that make up the data values G_M, G, H_M, H, I_M, I and the masks MG, MH and MI are all binary words with n bits.

In the extraction and insertion operation disclosed in relation with FIG. 5, a part G1_M of the masked data value G_M is extracted, then inserted into the masked data value H_M in order to form the final masked data value I_M. According to one embodiment, a part MG1 of the mask MG is further extracted, then inserted into the mask MH to form the mask MI.

More specifically, the part G1_M, respectively the part MG1, is a binary word with p bits, corresponding to the bits of the masked data value G_M, respectively of the mask MG, going from a rank m to a rank m+p−1.

According to one embodiment, the part G1_M, respectively the part MG1, is inserted into the masked data value H_M, respectively the mask MH, to form the masked data value I_M, respectively the mask MI, and more specifically, p bits of the masked data value H_M, respectively of the mask MH, going from the rank k to the rank k+p−1 are modified to form the masked data value I_M, respectively the mask MI. As disclosed in relation with FIGS. 2 and 3, the extraction and insertion operation can be with “compensation on the mask” or “compensation on the masked data value”.

The extraction and insertion operation disclosed here is intended to generate the masked data value I_M such that the data value I, obtained by unmasking the masked data value I_M with the mask MI, is equal to the data value H in which one has inserted, between ranks k and k+p−1, p bits of the data value G going from a rank m to a rank m+p−1.

In the case where the extraction and insertion operation is with “compensation on the masked data value”, the masked data value I_M is given by the following formula:

I_M[n−1;0]={(H_M[n−1k+p]−CH(k+p))*2^{(k+p)}+(G_M[m+p−1;m]−CG(m)+CG(m+p)*2^{p})*2^{k}+(H_M[k−1;0]+CH(k)*2^{k})}mod2ⁿ

wherein:

CH(i) represents a carry digit of rank i that may appear during the additive masking operation, with the mask MH, leading to the masked data value H_M; and

CG(i) represents a carry digit of rank i that may appear during the additive masking operation, with the mask MG, leading to the masked data value G_M.

The carry digit CH(i+1) is given by the following formulas:

$$\{ \begin{matrix}if H\_M [ i ; 0 ] < MH [ i ; 0 ] then CH ( i + 1 ) = 1 \\ if H\_M [ i ; 0 ] \geq MH [ i ; 0 ] then CH ( i + 1 ) = 0\end{matrix}$$

The carry digit CG(i+1) is given by the following formulas:

$$\{ \begin{matrix}if G\_M [ i ; 0 ] < MG [ i ; 0 ] then CG ( i + 1 ) = 1 \\ if G\_M [ i ; 0 ] \geq MG [ i ; 0 ] then CG ( i + 1 ) = 0\end{matrix}$$

The mask MI associated with the data value I_M is, in the case of an extraction and insertion operation with “compensation on the masked data value”, given by the following formula:

MI[n−1;0]=MH[n−1;k+p]*2^{k+p}+MG[m+p−1;m]*2^{k}+MH[k−1;0]

In the case where the extraction and insertion operation is with “compensation on the mask”, the masked data value I_M is given by the following formula:

I_M[n−1;0]={H_M[n−1;k+p]*2^{(k+p)}+(G_M[m+p−1;m]+CG(m+p)*2^{p})*2^{k}+(H_M[k−1;0]+CH(k)*2^{k})}mod2ⁿ

The mask MI, in this case, is given by the following formula:

MI[n−1;0]=(MH[n−1;k+p]+CH(k+p))*2^{k+p}30 (MG[m+p−1;m]+CG(m))*2^{k}+MH[p−1;0]mod2ⁿ

Whether in the case of an extraction and insertion operation with “compensation by the mask” or “with compensation by the masked data value”, the formulas defined above make it possible to find the data value I again from the masked data value I_M and the masked [sic] MI by applying an unmasking operation defined by the following formula:

I[n−1;0]=(I_M[n−1;0]MI[n−1;0])mod2ⁿ

One advantage of these embodiments is that the extraction and insertion operation does not require an unmasking operation for the masked data values G_M, H_M and I_M. Thus the data values G, H and I are not accessible during this operation.

Various embodiments and variants have been described. Those skilled in the art will understand that certain features of these embodiments can be combined and other variants will readily occur to those skilled in the art.

Finally, the practical implementation of the embodiments and variants described herein is within the capabilities of those skilled in the art based on the functional description provided hereinabove.

What is claimed is:

1. A method for processing masked binary data values, implemented by a device configured to perform calculations on binary data values, comprising:
extracting a first part (B1_M; D1_M; G1_M) of a first masked binary data value (B_M; D_M; G_M);
inserting the first part (B1_M; D1_M; G1_M) of the first masked binary data value (B_M; D_M; G_M) in a second masked binary data value (Z_M; X_M; E_M; H_M); and
keeping the first and second masked binary data values masked throughout the extracting and the inserting.

2. The method according to claim 1, further comprising not performing any unmasking operation of the first and second masked binary data values.

3. The method according to claim 1, further comprising masking the first and second masked binary data values by a masking operation comprising only arithmetic operations.

4. The method according to claim 3, wherein the masking operation comprises adding a data value to be masked (A) to a mask (MA) to obtain a masked data value (A_M).

5. The method according to claim 1, wherein a third binary data value (Z_M; X_M; F_M; I_M) is a result of the extracting and the inserting, and the third binary data value is a data value masked by a third mask (MZ; MX; MF; MI).

6. The method according to claim 5, further comprising obtaining a second masked binary data value (Z_M; X_M) by performing a masking operation of a binary data value (Z; X) having all bits equal to “o.”

7. The method according to claim 6, wherein the second masked binary data value (Z_M; X_M) is equal to a second mask (MZ; MX) used during the masking operation.

8. The method according to claim 6, wherein a third masked binary data value Z_M is given by the following formula:
Z_M[n−1;0]=(Z_M[n−1;p+1]*2^{p+1}+CB(p+m)*2^{p}+B_M[p+m−1;m])mod2ⁿ
where:
“+” represents an addition operation;
“mod” represents a modulo operation;
n represents a number of bits of the third masked binary data value Z_M, n being a natural integer;
p is a natural integer of between o and n−1;
m is a natural integer of between o and n−p;
P[i;j] represents all bits of a binary data value P ranging from a rank i to a rank j; i and j being natural integers;
CB(i) represents a carry digit of rank i that may appear during the masking operation leading to a first masked data value;
B_M represents the first masked data value,
a carry digit CB(i+1), i being a natural integer less than or equal to n, is given by the following formulas:
$$\{ \begin{matrix}if B\_M [ i ; 0 ] < MB [ i ; 0 ] then CB ( i + 1 ) = 1 \\ if B\_M [ i ; 0 ] \geq MB [ i ; 0 ] then CB ( i + 1 ) = 0\end{matrix}$$
where MB represents a first mask associated with the first masked binary data value, and a third mask MZ associated with the third masked binary data value is given by the following formula:
MZ[n−1;0]=(MZ[n−1;p+1]*2^{(p+1)}+CB(m)+MB[p+m1;m])mod2ⁿ.

9. The method according to claim 6, wherein a third masked binary data value X_M is given by the following formula:
X_M[n−1;0]=(Z_M[n−1;p+1]*2^{(p+1)}+CB(p+m)*2^{p}+B_M[p+m1;m]−CB(m))mod2ⁿ
where:
“+” represents an addition operation;
“mod” represents a modulo operation;
n represents a number of bits of the third masked binary data value X_M, n being a natural integer;
p is a natural integer of between o and n−1;
m is a natural integer of between o and n−p;
P[i;j] represents all bits of a binary data value P ranging from a rank i to a rank j;
i and j being natural integers;
CB(i) represents a carry digit of rank i that may appear during the masking operation leading to a first masked data value;
B_M represents the first masked data value,
a carry digit CB(i+1), i being a natural integer less than or equal to n, is given by the following formulas:
$$\{ \begin{matrix}if B\_M [ i ; 0 ] < MB [ i ; 0 ] then CB ( i + 1 ) = 1 \\ if B\_M [ i ; 0 ] \geq MB [ i ; 0 ] then CB ( i + 1 ) = 0\end{matrix}$$
where MB represents a first mask associated with the first masked binary data value, and a third mask MX associated with the third masked binary data value is given by the following formula:
MX[n−1;0]=(MX[n−1;p+1]*2^{(p+1)}+MB[p+m1;m])mod2ⁿ.

10. The method according to claim 5, wherein a third masked binary data value F_M is given by the following formula:
F_M[n−1;0]={E_M[n−1; k+p](CEF(k+p))*2^{(k+P)}+(D_M[m+p−1;m]+ME[k+p−1;k]−MD[m+p−1;m]+CE(k)−CD(k))*2^{k}+E_M[k−1;0]}mod2ⁿ
where:
“+” represents an addition operation;
“mod” represents a modulo operation;
n represents a number of bits of a third masked binary data value X_M, n being a natural integer;
p is a natural integer of between o and n−1;
m is a natural integer of between o and n−p;
k is a natural integer of between o and n−p;
P[i;j] represents all bits of a binary data value P ranging from a rank i to a rank j;i and j being natural integers;
CEF(i) represents a first carry digit correction with rank i;
CE(i) represents a second carry digit of rank i that may appear during a masking operation leading to a first masked data value;
CD(i) represents a third carry digit of rank i that may appear during a masking operation leading to a second masked data value;
D_M represents the first masked data value;
MD represents a mask associated with the first masked data value;
E_M represents the second masked data value; and
ME represents a mask associated with the second masked data value,
a carry digit CD(i+1) is given by the following formulas:
$$\{ \begin{matrix}if D\_M [ i ; 0 ] < MD [ i ; 0 ] then CD ( i + 1 ) = 1 \\ if D\_M [ i ; 0 ] \geq MD [ i ; 0 ] then CD ( i + 1 ) = 0\end{matrix}$$
a carry digit CE(i+1) is given by the following formulas:
$$\{ \begin{matrix}if E\_M [ i ; 0 ] < ME [ i ; 0 ] then CE ( i + 1 ) = 1 \\ if E\_M [ i ; 0 ] \geq ME [ i ; 0 ] then CE ( i + 1 ) = 0\end{matrix}$$
a carry digit correction CEF(i) is given by the following formula:
$$\{ \begin{matrix}if CE ( i ) = CF ( i ) then CEF ( i ) = 0 \\ if CE ( i ) = 0 and CF ( i ) = 1 then CEF ( i ) = 1 \\ if CE ( i ) = 1 and CF ( i ) = 0 then CEF ( i ) = - 1\end{matrix}$$
a third mask associated with the third binary data value is equal to the mask associated with the second masked data value.

11. The method according to claim 5, wherein a third masked binary data value F_M is given by the following formula:
F_M[n−1;0]={E_M[n−1;k+p]*2^{(k+p)}+(D_M[m+p−1;m]+ME[k+p−1;k]−MD[m+p−1;m]+CE(k)−CD(k))*2^{k}E_M[k−1;0]}mod2ⁿ
where:
“+” represents an addition operation;
“mod” represents a modulo operation;
n represents a number of bits of a third masked binary data value X_M, n being a natural integer;
p is a natural integer of between o and n−1;
m is a natural integer of between o and n−p;
k is a natural integer of between o and n−p;
P[i;j] represents all bits of a binary data value P ranging from a rank i to a rank j;i and j being natural integers;
CD(i) represents a first carry digit of rank i that may appear during a masking operation leading to a first masked data value;
CD(i) represents a second carry digit of rank i that may appear during a masking operation leading to a second masked data value;
D_M represents the first masked data value;
MD represents a mask associated with the first masked data value;
E_M represents the second masked data value; and
ME represents a mask associated with the second masked data value,
a carry digit CD(i+1) is given by the following formulas:
$$\{ \begin{matrix}if D\_M [ i ; 0 ] < MD [ i ; 0 ] then CD ( i + 1 ) = 1 \\ if D\_M [ i ; 0 ] \geq MD [ i ; 0 ] then CD ( i + 1 ) = 0\end{matrix}$$
a carry digit CE(i+1) is given by the following formulas:
$$\{ \begin{matrix}if E\_M [ i ; 0 ] < ME [ i ; 0 ] then CE ( i + 1 ) = 1 \\ if E\_M [ i ; 0 ] \geq ME [ i ; 0 ] then CE ( i + 1 ) = 0\end{matrix}$$
a third mask MF associated with the third binary data value is given by the following formula:
MF[n−1;0]=ME[n−1;0]−CEF(k+p)*2^{k+p}
where CEF(i) represents a carry digit correction with rank i given by the following formula:
$$\{ \begin{matrix}if CE ( i ) = CF ( i ) then CEF ( i ) = 0 \\ if CE ( i ) = 0 and CF ( i ) = 1 then CEF ( i ) = 1 \\ if CE ( i ) = 1 and CF ( i ) = 0 then CEF ( i ) = - 1.\end{matrix}$$

12. The method according to claim 5, wherein a third masked binary data value I_M is given by the following formula:
I_M[n−1;0]={(H_M[n−1;k+p]−CH(k+p))*2^{(k+p)}+(G_M[m+p−1;m]−CG(m)+CG(m+p)*2^{p})*2^{k}+(H_M[k−1;0]+CH(k)*2^{k)}}mod2ⁿ
where:
“+” represents an addition operation;
“mod” represents a modulo operation;
n represents a number of bits of a third masked binary data value X_M, n being a natural integer;
p is a natural integer of between o and n−1;
m is a natural integer of between o and n−p;
k is a natural integer of between o and n−p;
P[i;j] represents all bits of a binary data value P ranging from a rank i to a rank j;i and j being natural integers;
CG(i) represents a first carry digit of rank i that may appear during a masking operation leading to a first masked data value;
CH(i) represents a second carry digit of rank i that may appear during a masking operation leading to a second masked data value;
G_M represents the first masked data value;
G_M represents the second masked data value; and
a carry digit CG(i+1) is given by the following formulas:
$$\{ \begin{matrix}if G\_M [ i ; 0 ] < MG [ i ; 0 ] then CG ( i + 1 ) = 1 \\ if G\_M [ i ; 0 ] \geq MG [ i ; 0 ] then CG ( i + 1 ) = 0\end{matrix}$$
a carry digit CH(i+1) is given by the following formulas:
$$\{ \begin{matrix}if {H}_{M [ i ; 0 ]} < MH [ i ; 0 ] then CH ( i + 1 ) = 1 \\ if {H}_{M [ i ; 0 ]} \geq MH [ i ; 0 ] then CH ( i + 1 ) = 0\end{matrix}$$
a third mask MI associated with the third masked binary data value is given by the following formula:
MI[n−1;0]=MH[n−1;k+p]*2^{p+k}+MG[m+p−1;m]*2^{k}+MH[k−1;0]
where:
MG represents a mask associated with the first masked binary data value; and
MH represents a mask associated with the second masked binary data value.

13. The method according to claim ₅, wherein a third masked binary data value I_M is given by the following formula:
I_M[n−1;0]={H_M[n−1;k+p]*2^{(k+p)}+(G_M[m+p−1;m]+CG(m+p)*2^{p})*2^{k}+(H_M[k−1;0]+CH(k)*2^{k})}mod2ⁿ
where:
“+” represents an addition operation;
“mod” represents a modulo operation;
n represents a number of bits of a third masked binary data value X_M, n being a natural integer;
p is a natural integer of between o and n−1;
m is a natural integer of between o and n−p;
k is a natural integer of between o and n−p;
P[i;j] represents all bits of a binary data value P ranging from a rank i to a rank j; i and j being natural integers;
CG(i) represents a first carry digit of rank i that may appear during a masking operation leading to a first masked data value;
CH(i) represents a second carry digit of rank i that may appear during a masking operation leading to a second masked data value;
G_M represents the first masked data value;
G_M represents the second masked data value; and
a carry digit CG(i+1) is given by the following formulas:
$$\{ \begin{matrix}if G\_M [ i ; 0 ] < MG [ i ; 0 ] then CG ( i + 1 ) = 1 \\ if G\_M [ i ; 0 ] \geq MG [ i ; 0 ] then CG ( i + 1 ) = 0\end{matrix}$$
a carry digit CH(i+1) is given by the following formulas:
$$\{ \begin{matrix}if H\_M [ i ; 0 ] < MH [ i ; 0 ] then CH ( i + 1 ) = 1 \\ if H\_M [ i ; 0 ] \geq MH [ i ; 0 ] then CH ( i + 1 ) = 0\end{matrix}$$
a third mask MI associated with the third masked binary data value is given by the following formula:
MI[n−1;0]=(MH[n−1;k+p]+CH(k+p))*2^{p+k}+(MG[m+p−1;m]+CG(m))*2^{k}+)MH[k−1;0]
where:
MG represents a mask associated with the first masked binary data value; and
MH represents a mask associated with the second masked binary data value.

14. A device configured to perform calculations on masked binary data values, the device comprising:
a processor configured to:
extract a first part (B1_M; D1_M; G1_M) of a first masked binary data value (B_M; D_M; G_M);
insert the first part (B1_M; D1_M; G1_M) of the first masked binary data value (B_M; D_M; G_M) in a second masked binary data value (Z_M; X_M; E_M; H_M); and
keep the first and second masked binary data values masked throughout the extracting and the inserting.

15. The device according to claim 14, the processor further configured to not perform any unmasking operation of the first and second masked binary data values.

16. The device according to claim 14, wherein the processor is configured to mask the first and second masked binary data values by a masking operation comprising only arithmetic operations.

17. The device according to claim 16, wherein the masking operation comprises the processor configured to add a data value to be masked (A) to a mask (MA) to obtain a masked data value (A_M).

18. The device according to claim 14, wherein a third binary data value (Z_M; X_M; F_M; I_M) is a result of the extraction and the insertion, and the third binary data value is a data value masked by a third mask (MZ; MX; MF; MI).

19. The device according to claim 18, wherein the processor is configured to obtain a second masked binary data value (Z_M; X_M) by performing a masking operation of a binary data value (Z; X) having all bits equal to “o.”

20. The device according to claim 19, wherein the second masked binary data value (Z_M; X_M) is equal to a second mask (MZ; MX) used during the masking operation.

21. The device according to claim 19, wherein a third masked binary data value Z_M is given by the following formula:
Z_M[n−1;0]=(Z_M[n−1;p+1]*2^{p+1}+CB(p+m)*2^{p}+B_M[p+m−1; m])mod2ⁿ
where:
“+” represents an addition operation;
“mod” represents a modulo operation;
n represents a number of bits of the third masked binary data value Z_M, n being a natural integer;
p is a natural integer of between o and n−1;
m is a natural integer of between o and n−p;
P[i;j] represents all bits of a binary data value P ranging from a rank i to a rank j; i and j being natural integers;
CB(i) represents a carry digit of rank i that may appear during the masking operation leading to a first masked data value;
B_M represents the first masked data value,
a carry digit CB(i+1), i being a natural integer less than or equal to n, is given by the following formulas:
$$\{ \begin{matrix}if B\_M [ i ; 0 ] < MB [ i ; 0 ] then CB ( i + 1 ) = 1 \\ if B\_M [ i ; 0 ] \geq MB [ i ; 0 ] then CB ( i + 1 ) = 0\end{matrix}$$
where MB represents a first mask associated with the first masked binary data value, and a third mask MZ associated with the third masked binary data value is given by the following formula:
MZ[n−1;0]=(MZ[n−1;p+1]*2^{(p+1)}+CB(m)+MB[p+m−1;m])mod2ⁿ.

22. The device according to claim 19, wherein a third masked binary data value X_M is given by the following formula:
X_M[n−1;0]=(Z_M[n−1;p+1]*2^{p+1}+CB(p+m)*2^{p}+B_M[p+m−1;m]−CB(m))mod2ⁿ
where:
“+” represents an addition operation;
“mod” represents a modulo operation;
n represents a number of bits of the third masked binary data value X_M, n being a natural integer;
p is a natural integer of between o and n−1;
m is a natural integer of between o and n−p;
P[i;j] represents all bits of a binary data value P ranging from a rank i to a rank j; i and j being natural integers;
CB(i) represents a carry digit of rank i that may appear during the masking operation leading to a first masked data value;
B_M represents the first masked data value,
a carry digit CB(i+1), i being a natural integer less than or equal to n, is given by the following formulas:
$$\{ \begin{matrix}if B\_M [ i ; 0 ] < MB [ i ; 0 ] then CB ( i + 1 ) = 1 \\ if B\_M [ i ; 0 ] \geq MB [ i ; 0 ] then CB ( i + 1 ) = 0\end{matrix}$$
where MB represents a first mask associated with the first masked binary data value, and a third mask MX associated with the third masked binary data value is given by the following formula:
MX[n−1;0]=(MX[n−1;p+1]*2^{(p+1)}+MB[p+m−1;m])mod2ⁿ.

23. The device according to claim 18, wherein a third masked binary data value F_M is given by the following formula:
F_M[n−1;0]={E_M[n−1;k+p](+CEF(k+p))*2^{(k+p)}+(D_M[m+p−1;m]+ME[k+p−1;k]−MD[m+p−1;m]+CE(k)−CD(k))*2^{k}+E_M[k−1;0]}mod2ⁿ
where:
“+” represents an addition operation;
“mod” represents a modulo operation;
n represents a number of bits of a third masked binary data value X_M, n being a natural integer;
p is a natural integer of between o and n−1;
m is a natural integer of between o and n−p;
k is a natural integer of between o and n−p;
P[i;j] represents all bits of a binary data value P ranging from a rank i to a rank j; i and j being natural integers;
CEF(i) represents a first carry digit correction with rank i;
CE(i) represents a second carry digit of rank i that may appear during a masking operation leading to a first masked data value;
CD(i) represents a third carry digit of rank i that may appear during a masking operation leading to a second masked data value;
D_M represents the first masked data value;
MD represents a mask associated with the first masked data value;
E_M represents the second masked data value; and
ME represents a mask associated with the second masked data value,
a carry digit CD(i+1) is given by the following formulas:
$$\{ \begin{matrix}if D\_M [ i ; 0 ] < MD [ i ; 0 ] then CD ( i + 1 ) = 1 \\ if D\_M [ i ; 0 ] \geq MD [ i ; 0 ] then CD ( i + 1 ) = 0\end{matrix}$$
a carry digit CE(i+1) is given by the following formulas:
$$\{ \begin{matrix}if E\_M [ i ; 0 ] < ME [ i ; 0 ] then CE ( i + 1 ) = 1 \\ if E\_M [ i ; 0 ] \geq ME [ i ; 0 ] then CE ( i + 1 ) = 0\end{matrix}$$
a carry digit correction CEF(i) is given by the following formula:
$$\{ \begin{matrix}if CE ( i ) = CF ( i ) then CEF ( i ) = 0 \\ if CE ( i ) = 0 and CF ( i ) = 1 then CEF ( i ) = 1 \\ if CE ( i ) = 1 and CF ( i ) = 0 then CEF ( i ) = - 1\end{matrix}$$
a third mask associated with the third binary data value is equal to the mask associated with the second masked data value.

24. The device according to claim 18, wherein a third masked binary data value F_M is given by the following formula:
F_M[n−1;0]={E_M[n−1;k+p]*2^{(k+p)}+(D_M[m+p−1;m]+ME[k+p−1;k]−MD[m+p−1;m]−CE(k)−CD(k))*2^{k}+E_M[k−1;0]}mod2ⁿ
where:
“+” represents an addition operation;
“mod” represents a modulo operation;
n represents a number of bits of a third masked binary data value X_M, n being a natural integer;
p is a natural integer of between o and n−1;
m is a natural integer of between o and n−p;
k is a natural integer of between o and n−p;
P[i;j] represents all bits of a binary data value P ranging from a rank i to a rank j; i and j being natural integers;
CD(i) represents a first carry digit of rank i that may appear during a masking operation leading to a first masked data value;
CD(i) represents a second carry digit of rank i that may appear during a masking operation leading to a second masked data value;
D_M represents the first masked data value;
MD represents a mask associated with the first masked data value;
E_M represents the second masked data value; and
ME represents a mask associated with the second masked data value,
a carry digit CD(i+1) is given by the following formulas:
$$\{ \begin{matrix}if D\_M [ i ; 0 ] < MD [ i ; 0 ] then CD ( i + 1 ) = 1 \\ if D\_M [ i ; 0 ] \geq MD [ i ; 0 ] then CD ( i + 1 ) = 0\end{matrix}$$
a carry digit CE(i+1) is given by the following formulas:
$$\{ \begin{matrix}if E\_M [ i ; 0 ] < ME [ i ; 0 ] then CE ( i + 1 ) = 1 \\ if E\_M [ i ; 0 ] \geq ME [ i ; 0 ] then CE ( i + 1 ) = 0\end{matrix}$$
a third mask MF associated with the third binary data value is given by the following formula:
MF[n−1;0]=ME[n−1;0]−CEF(k+p)*2^{k+p}
where CEF(i) represents a carry digit correction with rank i given by the following formula:
$$\{ \begin{matrix}if CE ( i ) = CF ( i ) then CEF ( i ) = 0 \\ if CE ( i ) = 0 and CF ( i ) = 1 then CEF ( i ) = 1 \\ if CE ( i ) = 1 and CF ( i ) = 0 then CEF ( i ) = - 1.\end{matrix}$$

25. The device according to claim 18, wherein a third masked binary data value I_M is given by the following formula:
I_M[n−1;0]={(H_M[n−1;k+p]−CH(k+p))*2^{(k+p)}+(G_M[m+p−1;m]CG(m)+CG(m+p)*2^{p})*2^{k}+(H_M[k−1;0]+CH(k)*2^{k})}mod2ⁿ
where:
“+” represents an addition operation;
“mod” represents a modulo operation;
n represents a number of bits of a third masked binary data value X_M, n being a natural integer;
p is a natural integer of between o and n−1;
m is a natural integer of between o and n−p;
k is a natural integer of between o and n−p;
P[i;j] represents all bits of a binary data value P ranging from a rank i to a rank j; i and j being natural integers;
CG(i) represents a first carry digit of rank i that may appear during a masking operation leading to a first masked data value;
CH(i) represents a second carry digit of rank i that may appear during a masking operation leading to a second masked data value;
G_M represents the first masked data value;
G_M represents the second masked data value; and
a carry digit CG(i+1) is given by the following formulas:
$$\{ \begin{matrix}if G\_M [ i ; 0 ] < MG [ i ; 0 ] then CG ( i + 1 ) = 1 \\ if G\_M [ i ; 0 ] \geq MG [ i ; 0 ] then CG ( i + 1 ) = 0\end{matrix}$$
a carry digit CH(i+1) is given by the following formulas:
$$\{ \begin{matrix}if {H}_{M [ i ; 0 ]} < MH [ i ; 0 ] then CH ( i + 1 ) = 1 \\ if {H}_{M [ i ; 0 ]} \geq MH [ i ; 0 ] then CH ( i + 1 ) = 0\end{matrix}$$
a third mask MI associated with the third masked binary data value is given by the following formula:
MI[n−1;0]=MH[n−1;k+p]*2^{p+k}+MG[m+p−1;m]*2^{k}+MH[k−1;0]
where:
MG represents a mask associated with the first masked binary data value; and
MH represents a mask associated with the second masked binary data value.

26. The device according to claim 18, wherein a third masked binary data value I_M is given by the following formula:
I_M[n−1;0]={I_M[n−1;k+p]*2^{(k+p)}+(G_M[m+p−1;m]+CG(m+p)*2^{p})*2^{k}+(H_M[k−1;0]+CH(k)*2^{k})}mod2ⁿ
where:
“+” represents an addition operation;
“mod” represents a modulo operation;
n represents a number of bits of a third masked binary data value X_M, n being a natural integer;
p is a natural integer of between o and n−1;
m is a natural integer of between o and n−p;
k is a natural integer of between o and n−p;
P[i;j] represents all bits of a binary data value P ranging from a rank i to a rank j; i and j being natural integers;
CG(i) represents a first carry digit of rank i that may appear during a masking operation leading to a first masked data value;
CH(i) represents a second carry digit of rank i that may appear during a masking operation leading to a second masked data value;
G_M represents the first masked data value;
G_M represents the second masked data value; and
a carry digit CG(i+1) is given by the following formulas:
$$\{ \begin{matrix}if G\_M [ i ; 0 ] < MG [ i ; 0 ] then CG ( i + 1 ) = 1 \\ if G\_M [ i ; 0 ] \geq MG [ i ; 0 ] then CG ( i + 1 ) = 0\end{matrix}$$
a carry digit CH(i+1) is given by the following formulas:
$$\{ \begin{matrix}if H\_M [ i ; 0 ] < MH [ i ; 0 ] then CH ( i + 1 ) = 1 \\ if H\_M [ i ; 0 ] \geq MH [ i ; 0 ] then CH ( i + 1 ) = 0\end{matrix}$$
a third mask MI associated with the third masked binary data value is given by the following formula:
MI[n−1;0]=(MH[n−1;k+p]+CH(k+p))*2^{p+k}+(MG[m+p−1;m]+CG(m))*2^{k}+)MH[k−1;0]
where:
MG represents a mask associated with the first masked binary data value; and
MH represents a mask associated with the second masked binary data value.
